(19) United States
(12) Patent Application Publication
(10) Pub. No.: US 2010/0233646 A1
(43) Pub. Date: Sep. 16, 2010

(54) Dispenser For Paste-Like Mass

(76) Inventor: Petrus Johannes Wouter Brokx, Zeist (NL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(21) Appl. No.: 12/374,722

(22) PCT Filed: Mar. 13, 2008
(86) PCT No.: PCT/NL08/00078

§ 371 Date: Jan. 22, 2009

(51) Int. Cl. A61C 5/04; B05C 17/01; B05C 21/00

(52) U.S. Cl. 433/36; 433/89; 222/196; 222/327

(57) ABSTRACT

A dispenser for dispensing a viscous substance is described having a gun-shaped body with a grip part and a barrel part; a mouth piece arranged at an output end of the barrel part; a reception space at the output end for receiving a cartridge with the substance; a plunger accommodated displaceably in the barrel part for pressing the substance outwards out of the cartridge through the mouth piece; an actuator accommodated displaceably in the barrel part for displacing the plunger; an operating mechanism for operating the displacement of the actuator by a user; a vibration motor coupled to the plunger or to the actuator, which can be supplied by a battery to be placed in the grip; and a switch for switching the motor ON.

The present invention is in general related to a dispenser for paste-like or viscous substance. By way of example, the dispenser is intended for dispensing a filling material for filling a molar by a dentist, and the present invention will be explained specifically for this application example, but the invention is not limited thereto; in another example, the dispenser is intended for dispensing a glue.

When a dentist is going to fill a molar, he applies into the tooth cavity a portion of a tooth filling substance using a dispenser. Typically, this is a composite material which hardens after application, for instance under influence of UV-light, ambiance air, moisture, etc. Since filling teeth in this way, and materials suitable therefore, are known per se, a more detailed description thereof can be omitted.

In such case, an important problem is that the filling substance applied should fill the tooth cavity entirely. Deficiencies in this respect may lead to cavities in which for instance growth of bacteria can occur, which can further affect the molar concerned. Then, a complicating factor is that a good filling of the tooth cavity can actually only be achieved if the filling substance during application has a low viscosity; however, if the composition of the filling substance is chosen such that the filling substance, typically a plastic composite comprising a resin, has a low viscosity, a relatively strong shrinkage is typically to be expected on curing. Conversely, if the composition of the filling substance is chosen such that the filling substance hardly shrinks on curing, this typically goes hand in hand with a high viscosity, and filling the tooth cavity is difficult.

It is known to apply the filling substance using a gun-shaped dispenser, which at its output is provided with a narrow tube-shaped mouth piece, usually tapered, through which the filling substance is pressed. If the viscosity of the filling substance is high, it is very difficult to press the filling substance through the mouth piece, and this takes much force.

In order to reduce these problems, it has already been proposed to exert a vibration on the filling substance in the dispenser, having the result that the viscosity of the filling substance is lowered. As long as the filling substance “feels” the vibrations, i.e. within the dispenser and in the direct neighbourhood of the mouth piece, the filling substance has a low viscosity, and it is thus relatively easy to press the filling substance out of the mouth piece with relatively little force and to fill the tooth cavity well. When the dispenser is removed, the filling substance in the tooth cavity immediately assumes a high viscosity again. This has the additional advantage that the filling substance will not flow easily away out of the molar.

In the case of dispensers described in the state of the art, the vibrations have frequencies in the ultrasonic range. For generating these vibrations, complicated external apparatus are often needed, which must confirm the vibrations to the dispenser via hoses or the like. This makes the overall installation bulky and expensive, and makes it difficult to handle the dispenser. In this context it is meaningful that dispensers with vibrations are not available commercially. Also, dispensers have been described where use is made of a piezo element for generating the vibrations, but in that case it is difficult to obtain vibrations of sufficient energy. Further, the vibration-generating element is typically described as being positioned at a relatively large distance from the mouth piece, so that the vibrations must travel a relatively long way in the dispenser and it is difficult to obtain sufficient vibration energy at the right location.

The present invention aims to eliminate or at least reduce the problems mentioned. More particularly, the present invention aims to provide a simple and relatively cheap instrument, which is easy to handle, and which is capable of exerting an effective viscosity-reducing vibration on the filling substance for achieving a good filling result.

According to an important aspect of the present invention, the dispenser is provided with a simple battery-powered vibration motor. Experiments have shown that good results can be achieved in this way. The motor can be a relatively small motor, with an eccentric weight on its output axle. Such motors are known per se, for instance for tooth brushes, so that the design of the motor does not have to be explained in further detail. The said motors are manufactured in large numbers and are therefore relatively cheap.

These and other aspects, features and advantages of the present invention will be further clarified by the following description with reference to the drawings, in which same reference numerals indicate same of similar parts, and in which:

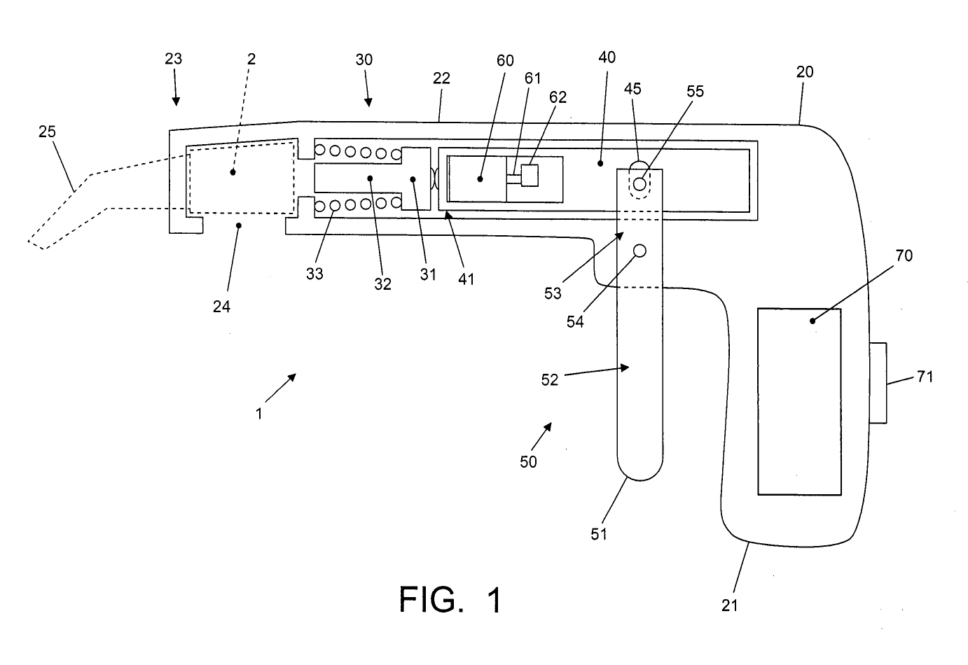

FIG. 1 schematically shows a longitudinal section of a possible embodiment of a dispenser proposed by the present invention;

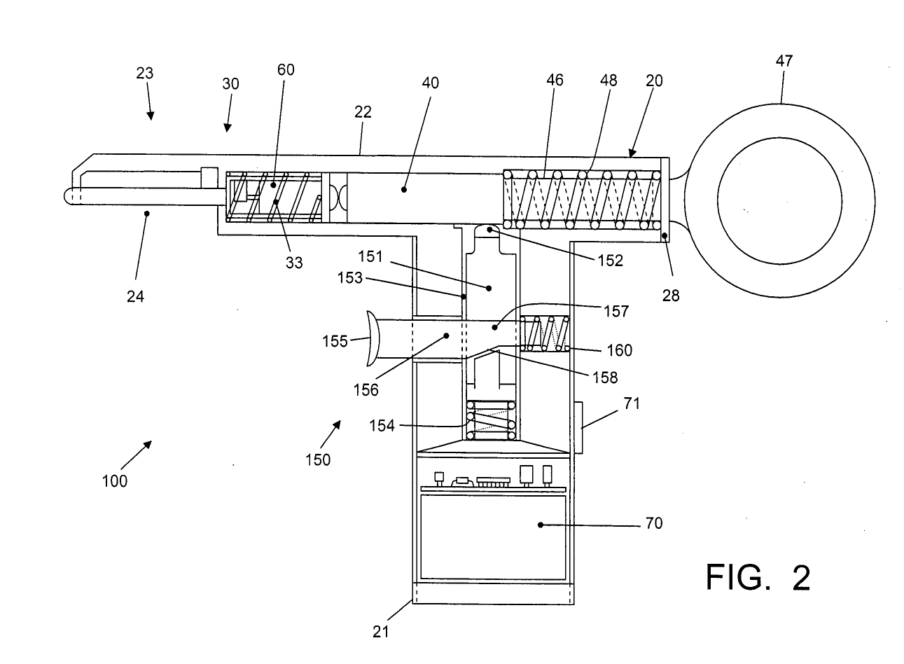

FIG. 2 schematically shows a detail of another embodiment of a dispenser proposed by the present invention.

In FIG. 1, a dispenser 1 according to the present invention is shown schematically in order to illustrate the principle of operation thereof. The dispenser 1 comprises a generally gun-shaped housing 20, with a grip part 21 and a barrel part 22, the grip part 21 extending almost perpendicularly to the barrel part 22. At the free end 23 of the barrel part directed away from the grip part 21, also indicated as front end, the barrel part 22 has a reception space 24 for receiving an ampoule or cartridge 2 with a filling paste. Further, a dispensing mouth piece 25 is shown at the front end, which usually is a fixed part of the cartridge but this is not essential. It is also possible that the dispensing mouth piece is a loose component to be coupled to the cartridge or is a component of the housing 20, exchangeable or not. Since dispensers with receiving spaces for such cartridges are known per se, for instance from EP-1.210.025 or EP-0.726.738, a further explanation of this design is not necessary.

A plunger 31 is accommodated axially shiftable in the barrel part 22 close to the receiving space 24. In this embodiment, the plunger 30 has a substantially T-shaped longitudinal cross section, with an axial stem 32 and an anvil 31 having a diameter larger than that of the stem 32 attached to the end of the stem directed away from the receiving space 24. An in this case helix-shaped reset spring 33, which pushes against the front end 23 of the housing 20, engages below the anvil 31 in order to push the stem 32 away from the receiving space 24.

In the barrel part 22, further an actuator 40 is accommodated axially shiftable. A front end 41 of the actuator 40 is in contact with the anvil 31 of the plunger 30. It is also possible that the plunger 30 is fixedly attached to the actuator 40 or that the plunger 30 and the actuator 40 are formed as an integrated whole.

The dispenser 1 is further provided with an operating mechanism 50 for operating the actuator 40. The operating mechanism 50 has the task to exert on the activator 40 a force that can be controlled by the user, such that the actuator 40 together with the plunger 30 is pushed in the direction of the receiving space 24, against the reset force of the reset spring 33, so that the stem 32 will penetrate into the cartridge 2 and the paste-like substance present therein will be pushed outwards via the mouth piece 25, as will be clear to a person skilled in the art. The reset spring 33 has the task to push back the plunger 30 when the force exerted by the user is reduced.

The control mechanism 50 can be implemented in several ways, as will be clear to a person skilled in the art. In the illustrated embodiment, the operating mechanism 50 comprises a lever 51 with two lever arms 52 and 53, which lever 51 is hingedly coupled to the housing 20 at a hinge point 54. A first lever arm 52 extends substantially parallel to the grip 21, at the front side of this grip. A second lever 53 engages the actuator 40. This engagement can for instance be implemented by a pin displaceable in a groove, as shown. When a user grabs around the grip 21 and the first lever arm 52 with his hand and squeezes, the squeezing force causes the first lever arm 52 to be hinged towards the grip 21, counter-clockwise in the drawing. The second lever arm 53 then hinges in the same direction, and pushes the actuator 40 forwards, i.e. in the direction of the mouth piece 25, in which case the pin 55 at the end of the second lever arm 53 is subjected to an adapting displacement in the groove 45 of the actuator 40 in this case.

According to an important aspect of the present invention, a vibration motor 60 is mounted in or on the displaceable actuator 40. In the figure, the actuator is shown as being hollow, and the vibration motor 60 is positioned in the direct neighbourhood of the front end 41 of the actuator which is in contact with the plunger 30. The vibration motor is a relatively small motor, with dimensions in the order of some centimetres. The vibration motor may be implemented as a motor with a weight 62 mounted eccentrically on the output axle 61. In a suitable embodiment, use can be made of vibration motors such as known for application in electrical tooth brushes.

In the grip 21, a battery 70 is located, which provided electric power to the motor 60. Electric wiring is not shown for sake of simplicity. The dimension of the battery (therefore the type of battery) is adapted to the voltage requirement of the motor 60 and to the dimensions of the grip 21. The grip 21 may be provided with a removable lid or the like in order to be able to replace the battery when empty, but this is not shown. Alternatively, it is possible that the battery 70 is a rechargeable battery and that the grip is provided with an electric connector for connecting an external charging apparatus, or with a reception coil plus an associated electronic circuit for wirelessly receiving electromagnetic energy for charging the battery, but this is also not shown.

For actuating the motor 60, the dispenser is provided with a switch 71, that can be controlled by a user. Easy control becomes possible if the user can control this switch with the same hand that holds the dispenser and operates the operating mechanism 50, simultaneously with the operation of the operating mechanism 50. This advantage is for instance achieved if the switch 71 is mounted in the grip 21, preferably at the rear side of the grip 21 (i.e. at the side directed away from the lever 51), as illustrated. By way of alternative, the switch 71 might also be mounted at the front side of the lever 51. If it is desirable to prevent entry of dust and the like at the switch 71, the switch 71 may be covered by a flexible sealing member, for instance made of rubber or silicone.

The operation is as follows. The user places a cartridge 2 into the receiving space 24, together with a possible separate mouth piece 25. Subsequently, he brings the mouth piece 25 to the place where the paste-like substance is to be dispensed, and squeezes the lever 51 and the grip 21 toward each other, thus also depressing the switch 71, causing the actuator to be pressed against the plunger, causing the plunger 30 to be pressed against the cartridge 2, and the motor 60 is switched on. The motor generates a low frequency vibration of the actuator 40, of which the frequency may for instance lie in the range of about 1 Hz to about 3000 Hz, although higher or lower frequencies are not excluded; in any case, the vibration is substantially less than ultrasonic. A practically suitable frequency lies for instance in the range of 50 to 150 Hz. The generated vibration is transferred by the actuator 40 via the plunger 30 to the paste-like substance pressed out from the cartridge by the plunger, which eventually results in a lowering of the viscosity of this substance.

FIG. 2 illustrates another dispenser 100 according to the present invention. At its rear side, the actuator 40 is provided with a rod 46 extending outwards from the housing 20 and being provided with a grip 47 at its rear end, a ring-shaped grip in the example shown. The actuator 40 is further provided with a force member 48 capable of exerting on the actuator 40 a force directed forwards (i.e. directed in the direction of the mouth piece 25). In the embodiment shown, this force member 48 is implemented as a helix-shaped pressure spring around the rod 46, which pressure spring on the one hand supports against a rear face of the actuator 40 and on the other hand supports against a support face 28 of the housing 20. The user can put tension on the spring 48 by pulling the ring-shaped grip 47 backwards.

The control mechanism 150 in this embodiment comprises a brake to be controlled by the user. This brake may be implemented as a friction brake or as a ratchet. By depressing a pressure button, the braking force is reduced, and the spring presses with more force. Since in this case the pressure needed for pressing the paste-like substance outwards is provided by the spring, and the user needs only to exert relatively little force in order to reduce the braking action, the advantage is achieved that the user can comfortably dose the discharge of this substance with relatively little force.

In the embodiment shown, the control mechanism 150 comprises a brake body 152 with a brake shoe 152 at an upper end, which brake body 151 is accommodated vertically shiftable in a chamber 153 in the grip 21, with a pressure spring 154 between the break body 151 and the bottom of this chamber 153. Under normal circumstances, the pressure spring 154 presses the brake body 151 upwards against the actuator 40 with such force that the resulting friction force is sufficient to counteract the pressure force of the spring 48 and to keep the actuator 40 stationary.

The control mechanism 150 further comprises a pressure button 155 horizontally displaceable in the grip 21, of which a wedge 156 extends through an opening 157 in the brake body 151. At its lower side, the wedge 156 has an inclined face 158, which cooperates with an inclined face at the lower side of said opening 157. When the user depresses the pressure button 155 and thus presses the wedge 156 inwards, the brake body 151 is pressed downward a little bit causing the upwards directed pressure force of the brake shoe 152 against the actuator 40 to be reduced, causing in turn the friction force to be reduced and the pressure force of the spring 48 to become larger than this friction force.

When the user lets go of the pressure button 155, this pressure button is pressed outwards by a reset spring 160, causing the pressure force of the brake shoe 152 against the actuator 40 to be increased again.

It will be clear to a person skilled in the art that the invention is not limited to the exemplary embodiments discussed in the above but that several variations and modifications are possible within the protective scope of the invention as defined in the attached claims.

For instance, it is possible that the motor 60 is incorporated in the plunger 30 in stead of in the actuator 40, which is illustrated in the embodiment 100 of FIG. 2 but can also be applied in the embodiment 1 of FIG. 1. It is also possible that the plunger and the actuator form an integrated whole.

1. Dispenser for dispensing a viscous substance, comprising:
a gun-shaped body with a grip part and a barrel part;
a mouth piece arranged at an output end of the barrel part;
a reception space at said output end for receiving a cartridge with said substance;
a plunger accommodated displaceably in the barrel part for pressing said substance outwards out of said cartridge through the mouth piece;
an actuator accommodated displaceably in the barrel part for displacing the plunger;
an operating mechanism for operating the displacement of the actuator by a user;
a vibration motor coupled to the plunger or to the actuator, which can be supplied by a battery to be placed in the grip;
a switch for switching the motor ON or OFF.

2. Dispenser according to claim 1, wherein the vibration motor is mounted in or on the plunger.

3. Dispenser according to claim 1, wherein the vibration motor is mounted in or on the actuator.

4. Dispenser according to claim 1, wherein the plunger and the actuator are implemented as an integrated whole, and wherein the vibration motor is mounted in or on this integrated whole.

5. Dispenser according to claim 1, wherein the switch is mounted in or on the grip.

6. Dispenser according to claim 1, wherein the operating mechanism comprises a lever or pressure button displaceable with respect to the grip, and wherein the switch is mounted in or on this lever or is mounted in or on this pressure button, respectively.

7. Dispenser according to claim 1, wherein the operating mechanism comprises a pressure spring for exerting on the actuator a pressure force, and wherein the operating mechanism comprises a brake to be operated by the user.

8. Dispenser according to claim 7, wherein the operating mechanism comprises a brake body pressed against the actuator by a pressure spring, with a brake shoe at an upper end;
and wherein the operating mechanism comprises a wedge to be operated by a pressure button displaceable in the grip, which wedge extends through an opening in the brake body, which wedge has an inclined face coopering with an inclined face of said opening.
